(19) United States
(12) Patent Application Publication
(10) Pub. No.: US 2014/0068489 A1
(43) Pub. Date: Mar. 6, 2014

(54) INTERACTIVE HISTORICAL TIMELINE OF PERSONAL HEALTH RECORD

(71) Applicant: INTELLIGENT DECISIONS, INC., Ashburn, VA (US)

(72) Inventors: Robert Wyland, Sterling, VA (US); Gregory Eoyang, Rockville, MD (US)

(73) Assignee: INTELLIGENT DECISIONS, INC., Ashburn, VA (US)

(21) Appl. No.: 14/013,372

(22) Filed: Aug. 29, 2013

Related U.S. Application Data
(60) Provisional application No. 61/696,876, filed on Sep. 5, 2012.

(51) Int. Cl. G06F 19/00

(52) U.S. Cl. CPC G06F 19/3406
USPC 715/771

(57) ABSTRACT

The present invention relates to methods and devices for graphically presenting medical information in an interactive timeline. Methods of the invention can include generating a visual display on a display screen of an electronic device, in which the visual display includes a configurable timeline representative of a patient's medical data. Devices of the invention can involve a display screen, a processor, and computer instructions that when executed by the processor, generate a visual display on the display screen, in which the visual display includes a configurable timeline representative of a patient's medical data.

### RELATED APPLICATIONS

The present application claims the benefit of and priority to U.S. provisional application Ser. No. 61/696,876, filed Sep. 5, 2012, the contents of which are incorporated by reference herein.

### FIELD OF THE INVENTION

The present invention generally relates to methods and devices for graphically presenting medical information in an interactive timeline.

### BACKGROUND

The storage and presentation of a patient's medical data presents particular challenges. A patient's medical history may be collected among numerous insurers, medical providers, and medical facilities across the country. Moreover, this information may be stored in a variety of media, from papers accumulating in accordion folders to electronic data stored in hard drives. Furthermore, similar data may be recorded by different healthcare providers that use text and graphical formatting in different ways, resulting in diverse styles of presentation.

In the past, data was collected on paper. Each healthcare provider stored records in filing cabinets, manually assembling data and collaborating with other providers by mail or telephone as necessary. In recent years, fax machines and internet communication partially resolved the speed and accuracy problems inherent to this system.

Further advances in technology have led to the storage of medical records in electronic databases. Patients can choose to upload their medical records to web-based databases and recall data as requested by medical personnel. The data is stored in a central processing location and presented in one of two ways: either as originally formatted by the medical provider, or in a text-based consolidation format deployed by the database operator.

Electronic health records databases have not succeeded commercially or in practice. One reason for their failure is that the unified storage of patient records raises privacy concerns, especially as these databases are vulnerable to system failure and hacking. Database operators may also utilize the patient's medical records for legally permissible advertising research, which also raises privacy concerns. Furthermore, the databases are not popular with medical personnel because the text-based data formatting employed by some operators can be cumbersome to interpret. Thus, the task of organizing data into a cohesive report remains tedious and prone to error.

Effective medical treatment requires a holistic picture of a patient's health, which is hindered by the collection of medical data in difficult formats and from disparate sources. Currently, each provider must recall and interpret data piece by piece whenever medical treatment is required. This hinders diagnosis of a patient's condition, may delay treatment, and often risks exposure of sensitive private information to untrustworthy third parties. Accordingly, there remains a need to store a patient's medical data in a way that addresses privacy concerns and that facilitates the presentation of data from disparate sources in an easily understandable manner.

### SUMMARY

The present invention provides visual displays of a patient's medical data onto personal electronic devices belonging to the patient. This medical data may originate from multiple sources of medical information, including service providers previously responsible for the patient's treatment. Because the medical data is stored on the patient's personal electronic device as opposed to a shared database, the patient's aggregated medical records maintain some degree of privacy. Moreover, the provided visual displays facilitate the comprehension of aggregate medical data in one easy-to-understand format. In preferred embodiments of the invention, this format is an interactive timeline representative of the patient's medical data.

The interactive historical timeline is a means of displaying and interacting with a person's health record and health-related events relevant to their lifespan. Because medical information is typically verbose and fragmented throughout a network of providers, both patients and practitioners spend needless time completing and reviewing paperwork, yet still miss important trends and issues in a patient's medical history. This can further complicate health assessment and may result in unnecessary worsening of condition or even death. The provided timelines portray a high-level view of a patient's medical history in a graphical and interactive experience, which facilitates diagnosis due to the ability to depict different types of health data on the same chart based on when the event occurred.

In certain aspects, the invention relates to electronic devices for storing and presenting a patient's medical data. The device may include a display screen, a processor, and computer instructions that when executed by the processor, generate a visual display on the display screen. In certain aspects, the visual display includes an interactive or configurable timeline representative of the patient's medical data.

In certain aspects, the invention relates to methods for presenting a patient's medical data. The method may involve generating a visual display on a display screen of an electronic device, in which the visual display includes a configurable timeline representative of the patient's medical data.

While any electronic device can be used with the invention, in a preferred aspect, the electronic device is portable electronic device, such as a tablet, personal digital assistant, or smartphone. These devices typically feature screens useful for displaying medical information in accordance with the invention. Furthermore, these devices often feature touch-sensitive screens, which in accordance with the invention, can be used to manipulate the provided interactive timelines.

The provided medical data timelines are interactive or configurable. This means that the presentation of the timeline, including the timeline itself, its axes, or any information presented on or in association with the timeline may be adjusted as desired by the viewer. Although any means can be used to manipulate the timeline, in certain aspects, the user can manipulate the timeline using the touch-sensitive screen of the device. For example, the user may touch the screen of the device with one finger and swipe to the left or right, which moves the timeline to the left or right accordingly. The user may also bring two contact points closer together, which can zoom out the display, or move the contact points further apart, which can zoom in the display.

Any aspect of medical data can be represented with the provided timelines. For example, the medical data may relate to one or more of the patient's physiological parameters, such as the patient's height, weight, blood pressure, or blood sugar. The displayed medical data may also relate to medical events that the patients has experienced. Medical events can encompass a medical procedure, such as an angioplasty, or an adverse bodily event, such as a stroke. Other medical events suitable for display include occurrences in which a particular medication was taken or when an immunization bolus was delivered. In short, any aspect of the patient's medical history may be represented on the provided timelines.

In addition to the features described above, other aspects of the invention will become apparent upon review of the following disclosure.

### BRIEF DESCRIPTION OF THE DRAWINGS

FIG. 1 is a visual display depicting one embodiment of an interactive timeline representative of a patient's medical data.

FIG. 2 is a visual display depicting the interactive timeline of FIG. 1 advanced to a different point on the timeline.

FIG. 3 is visual display depicting an interactive timeline prior to collapsing a range of dates on the timeline.

FIG. 4 is visual display depicting the interactive timeline of FIG. 3 as a range of dates is collapsed on the timeline.

FIG. 5 is a visual display depicting the interactive timeline of FIG. 3 subsequent to collapsing a range of dates on the timeline.

FIG. 6 is a visual display depicting various medications taken by a patient over the range of the timeline.

FIG. 7 is a visual display depicting a patient medical profile page.

FIG. 8 is a visual display depicting a second embodiment of an interactive timeline representative of a patient's medical data, prior to collapsing a range of dates on the timeline.

FIG. 9 is a visual display depicting the interactive timeline of FIG. 8 as a range of dates is collapsed on the timeline.

FIG. 10 is a visual display depicting the interactive timeline of FIG. 8, showing a combination of medications from multiple data sources on a single timeline.

FIG. 11 is a visual display depicting the interactive timeline of FIG. 8, including a few points on the timeline where the measured parameter exceeds a threshold level for that parameter.

FIG. 12 is a visual display depicting the interactive timeline of FIG. 8 showing a number of medical events on the same timeline.

FIG. 13 is a flowchart depicting an exemplary process for obtaining medical data used in the interactive timelines of the invention.

### DETAILED DESCRIPTION

The invention generally relates to the graphic presentation of patient medical data and associated devices and methods. Methods of the invention may involve generating a visual display on a display screen of an electronic device, in which the visual display includes a configurable timeline representative of the patient's medical data. Devices of the invention may include a display screen, a processor, and computer instructions to be executed by the processor for generating a visual display on the display screen.

While any electronic device can be used with the invention, in a preferred aspect, the electronic device is a portable electronic device, such a tablet, personal digital assistant, or smartphone. Of course, other electronic devices can be used which are larger than the aforementioned devices, including desktop computers and laptops.

Typically, electronic devices in accordance with invention will include a display screen and a processor for executing computer instructions. Electronic devices in accordance with the invention may further include computer instructions for executing by the processor to generate a visual display on the display screen. The visual display comprises a configurable timeline representative of a patient's medical data.

Computer instructions may be provided in any form, including software, computer programs, or computer applications or “apps.” In a specific embodiment, the computer instructions are provided in an app. The app may be downloadable from a server contacted by the electronic device and installed thereon. The application/program is then executed by the processor of the electronic device.

The medical data used to generate the interactive timeline, in certain embodiments, is data requested by the device user via the device. In most cases, it is expected that the user is also the patient who is requesting his own medical data. Of course, the user may also be the patient's physician, spouse, or relative. The electronic device, in certain embodiments, is able to request the medical data electronically through accessing a server. This ability is typical of most smartphone and tablet devices.

It is provided that the medical data will originate from at least one source, but typically more than one source. These sources of data can include electronic databases that are maintained by the patient's insurance providers, medical practitioners that have treated the patient, and healthcare facilities where the patient has been treated. Often, these sources will maintain records of test results, medications prescribed to the patient, medical procedures performed on the patient, adverse bodily events experienced by the patient, allergic reactions, immunization schedules, and the like.

This data is requested by the patient/user using the provided electronic device and stored on the electronic device. Typically, suitable electronic devices, i.e. smartphones, tablets, laptops, etc. include some type of memory in which this medical data can be stored. Accordingly, the invention provides a means for collecting medical information from disparate sources and storing the aggregated information in one centralized location. This centralized location, however, is in the possession of the user/patient, which mitigates privacy concerns. In addition, electronic devices of this type typically feature passcodes that prevent those who do not know the code from accessing the device. In further embodiments of the invention, the software/program/application may also require a passcode to operate, which can be set by the user/patient.

Although the collected information may be stored in any number of electronic formats including Extensible Markup Language (XML) is a markup language that defines a set of rules for encoding documents in a format that is machine-readable. Specifically the health community has design a number of XML based schemas including CCR (Continuity of Care Record), CCD (Continuity of Care Document), CCDA (Continuity of Care Document Architecture and BlueButton+ emphasize simplicity, generality, and portability over the Internet. The current market for EHR (Electronic Health Records) is a vast mix of these standards and proprietary representations which change for each EHR vendor.

The medical data culled from the different sources is then used to generate an interactive timeline for representing the patient's medical history in a graphical format. Before this disparate data can be represented on the same graphical interface it must be standardized as part of the importing process. Each one of these formats, differing from different systems and versions of systems must be converted to a single format which can then be graphed regardless of source. This timeline is part of the visual display generated on the screen of the electronic device. The interactive historical timeline is a means of displaying and interacting with a person's health record and health-related events relevant to their lifespan. The provided timelines portray a high-level view of a patient's medical history in a graphical and interactive experience, which facilitates diagnosis due to the ability to depict different types of health data on the same chart based on when the event occurred.

The provided medical data timelines are interactive or configurable. This means that the presentation of the timeline, including the timeline itself, its axes, or any information presented on or in association with the timeline may be adjusted as desired by the user of the electronic device.

Any means can be used to adjust the interactive timeline. For example, the timeline may be adjusted using the pad or rollerball of a laptop, or through keys on a keyboard or keypad. In a preferred aspect, the electronic device has a touch-sensitive screen which can be used to manipulate the timeline. Touch-sensitive screens are a common feature of many smartphones, personal digital assistants, and tablets. As contemplated by the invention, the user may scroll through the timeline by touching the screen and swiping in a lateral direction. When scrolled, the timeline may display dates before or after the original range of dates displayed on the timeline. The user may also bring two contact points closer together, which can zoom out the display, or move the contact points further apart, which can zoom in the display. The zooming in and out can accordingly change the scale of the timeline. For example, weeks can be zoomed into days, or zoomed out into months.

Any type of medical event can be represented using the provided timeline. In particular embodiments, the medical information represented on the timeline relates to one or more of the patient's physiological parameters. These are physiological characteristics associated with the patient. Because these physiological characteristics may fluctuate over time and may also indicate trends in the patient's health, they are particularly amenable for tracking using the provided timelines. Any physiological parameter may be represented. In certain embodiments, physiological parameters may include the patient's height, weight, body mass index, body fat percentage, blood pressure, blood sugar, cholesterol, body temperature, heart rate, exercise metrics, and pain level. Obtaining measurements or results for many of these physiological parameters, including all of those just listed is well known in the art and routinely done by medical practitioners, healthcare facilities and personal device managers.

Visual displays of the invention can also include a threshold level indicated on the display for a particular physiological parameter. In certain embodiments, a parameter level above the threshold indicates a health risk. For example, a patient's blood sugar levels may be tracked on the timeline. A blood sugar level above the indicated threshold may signal diabetes, a health risk. In certain embodiments, a parameter level below the threshold indicates a health risk. For example, a patient's blood pressure may be below a predetermined threshold, which indicates hypotension, another health risk. The appropriate threshold levels for a given physiological parameter can be easily determined by turning to the appropriate reference. Many of these threshold levels are already known in the art and are easily accessible.

The provided visual displays may also depict certain medical events that occurred in the patient's medical history. These events are then further tracked on the provided timeline. Any medical event may be presented on the visual display and tracked on the timeline. A medical event can include a medical procedure undergone by the patient. For example, the patient may have had an endoscopy or angioplasty performed. Such events can be tracked on the timeline. Medical events can also include adverse bodily events experienced by the patient. For example, the patient may have experienced a heart attack or stroke, or even a fall in which a bone was broken. These events can also be tracked on the timeline. Other events can include medicines administered to the patient at certain times, i.e., a medication regimen, or immunizations given to the patient, i.e., an immunization schedule. Further events may also include allergic reactions experienced by the patient. Information regarding these medical events is typically catalogued by medical practitioners, healthcare providers, and medical insurance companies. Accordingly, such data can be imported as described above and stored onto the electronic device for generating the provided visual displays and interactive timelines.

The invention encompasses visual displays that depict multiple types of medical information simultaneously on the same display and on the same timeline. This helps the user become better aware of trends in the patient's health and how different medical events and physiological parameters are related. For example, the visual display may depict instances when the patient took his blood pressure medication while simultaneously tracking the patient's blood pressure on the timeline. As a result, the patient can better determine whether the medication is working or not. The same analysis can be performed using medical procedures depicted on the visual display. For instance, the patient may have had laparoscopic lap band surgery performed. Using the graphical displays described herein, the patient can easily monitor his body weight since the surgery.

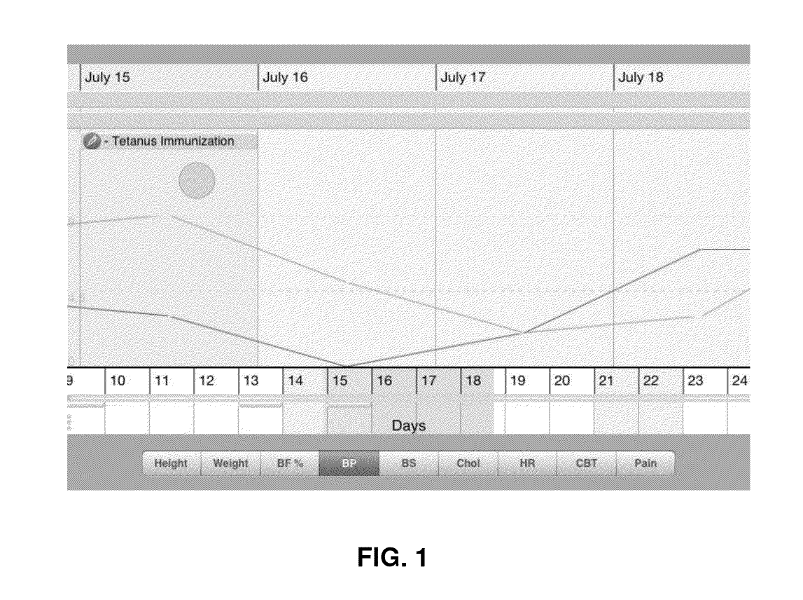

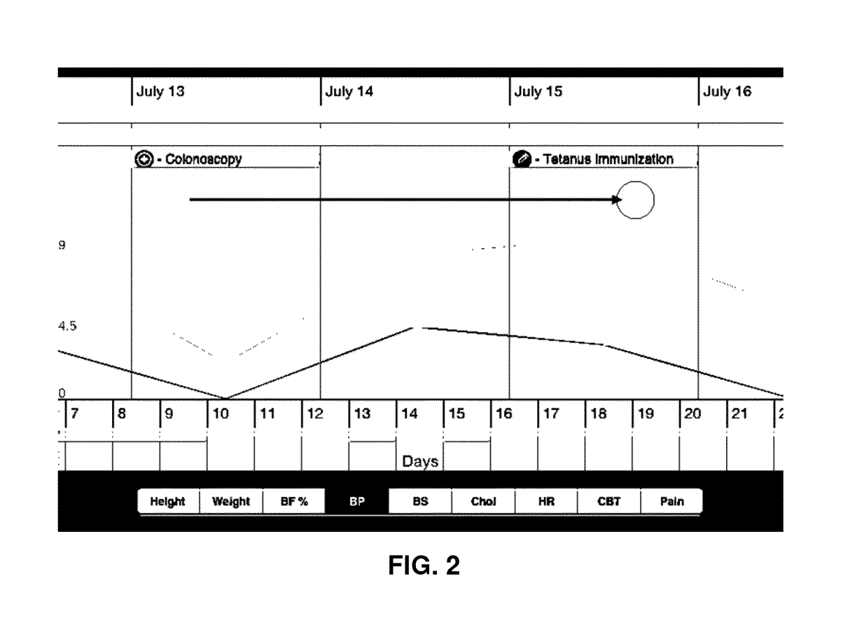

To better understand the invention, reference will now be made to the accompanying Figures. A visual display in accordance with the invention is provided in FIG. 1, which depicts a timeline representing the patient's blood pressure (BP)-related history. Although the timeline presented in FIG. 1 is tracking the patient's blood pressure, FIG. 1 also shows that other physiological parameters may be represented through the timeline, including Height, Weight, Percent Body Fat (BF %), Blood Sugar (BS), Cholesterol (Chol), Heart Rate (HR), Pain and Steps. The upper and lower lines of the timeline presented in FIG. 1 represent the patient's systolic and diastolic pressure, respectively. As shown in FIG. 1, temporal units orient the timeline. Although days are the temporal unit selected in FIG. 1, any temporal unit can be used, including minutes, hours, weeks, months, and years. In the screenshot provided, the timeline presents medical data from a four day range (July 15 to July 18) as shown at the top of the visual display, but also correspondingly, in a highlighted portion near the bottom of the visual display. The provided timeline indicates that the patient underwent a tetanus immunization on July 15 as well. The circle underneath the tetanus immunization icon schematically represents a contact point that the user would touch the touch-sensitive screen. By contacting the screen and swiping to one direction or the other, the user can scroll through the timeline. In FIG. 2, the user has swiped to the right (again schematically represented by the circle). As shown in FIG. 2, the timeline has shifted as a result, displaying a new range of dates (July 13 to July 16) with new information corresponding to one of those days (a colonoscopy was performed on July 13).

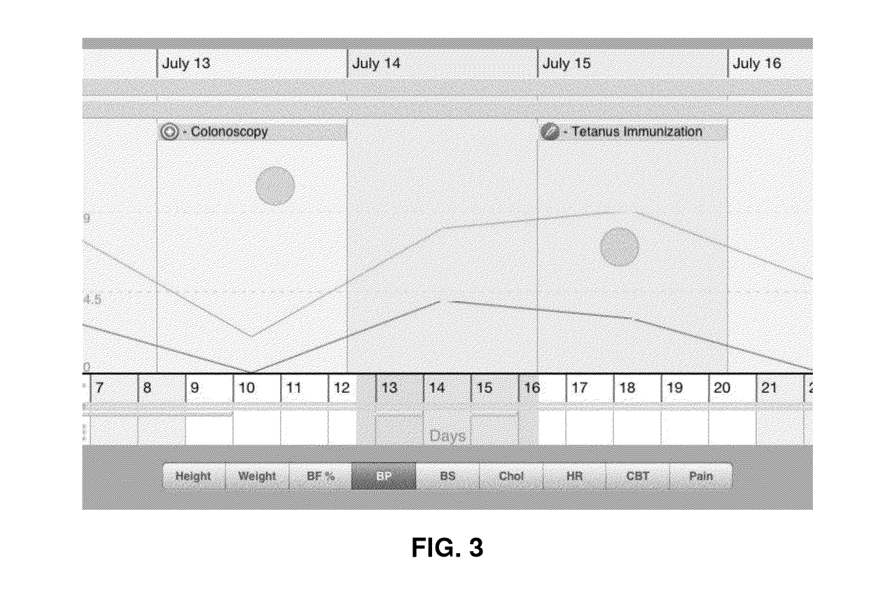

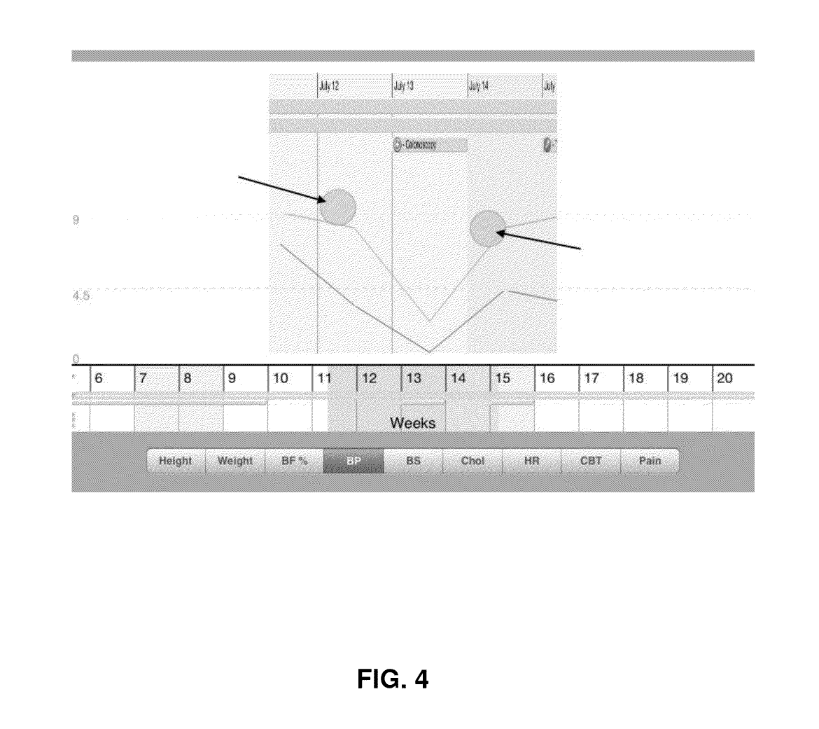

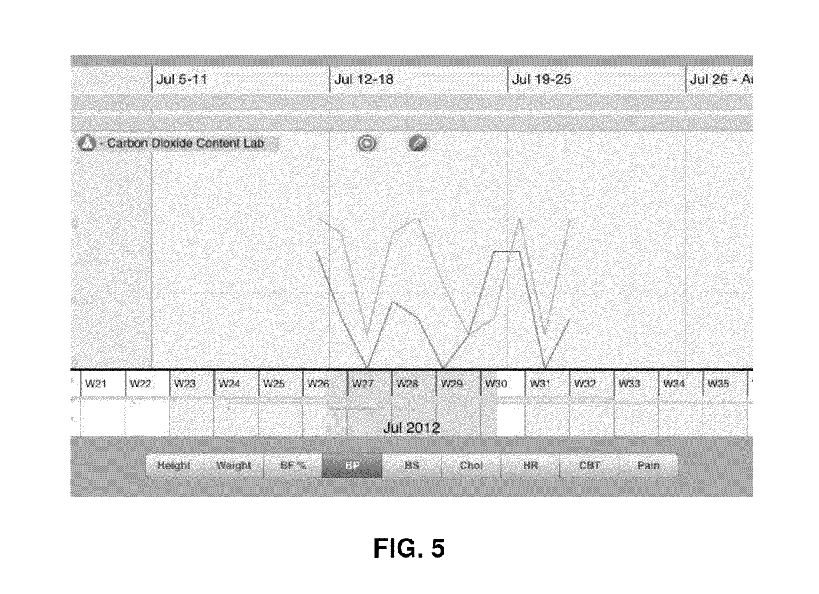

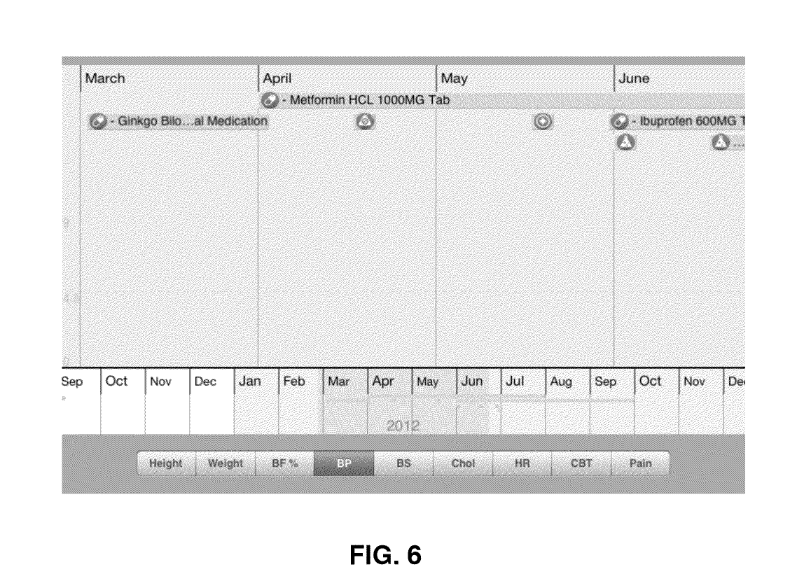

As shown in FIGS. 3-5, the provided timelines can be manipulated in other ways. In FIGS. 3-5, the user can manipulate the timeline by contacting the screen at two points (represented by the two circles in FIGS. 3 and 4) and moving or pinching those points closer to each other, as shown in FIG. 4. This results in zooming out of the previous displayed image. For example, the range of dates depicted in the screenshot of FIG. 3 was July 13 to July 16. After zooming out, the range of dates shown in FIG. 4 is now July 5 to August 1. Weeks can be further zoomed out into months as shown in FIG. 6. Although not shown in the Figures, the user can similarly contact the touchscreen of the electronic device and expand the points away from each other to zoom in on a particular range along the timeline (i.e., months to weeks, weeks to days). The provided interactive timelines can further facilitate navigation through a span of time by providing a legend of the relevant time period somewhere on the display. In the embodiment shown in FIGS. 3-6, the legend is positioned at the bottom of the display. The timeline may be a magnified portion of the display. For example, in FIG. 3, days 7-21 are indicated at the bottom of the visual display, but days 13-16 are actually highlighted. Correspondingly, the timeline above shows the relevant information from days 13-16. In FIG. 5, the legend indicates that the date range is now in weeks of the year (W21, W22, W23, etc.). The highlighted portion (W27-W29) is then magnified in the timeline above, depicting information from the corresponding days of the month, i.e., July 5-11, July 12-18, and July 19-25.

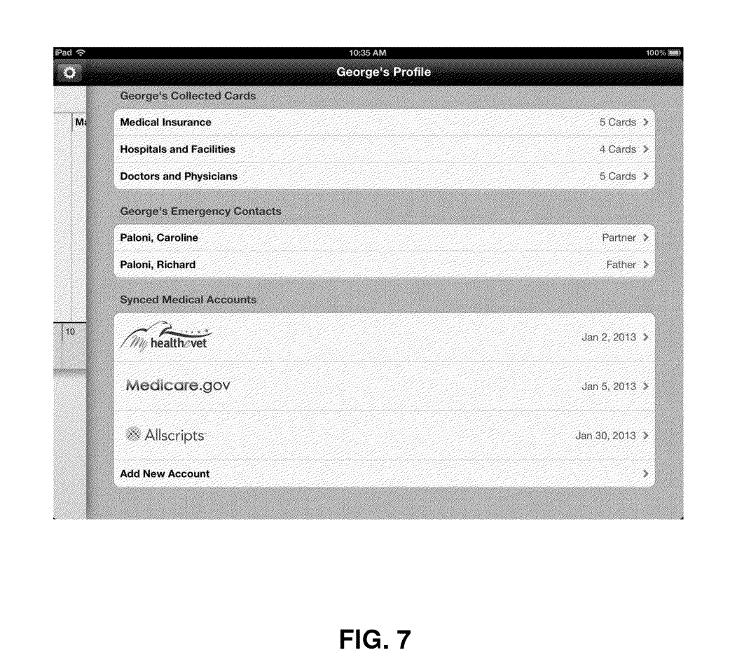

Further embodiments of the invention can comprise visual displays that depict a profile of the patient. As shown in FIG. 7, this profile page can include the patient's medical insurance providers, hospitals and facilities where the patient has received treatment, and doctors and physicians that have treated the patient. The profile page can also include the patient's emergency contacts. The profile page can further include the patient's medical accounts synchronized to provide the patient's medical data for generating the interactive timeline. As shown, multiple medical accounts may be used to provide information for the timeline.

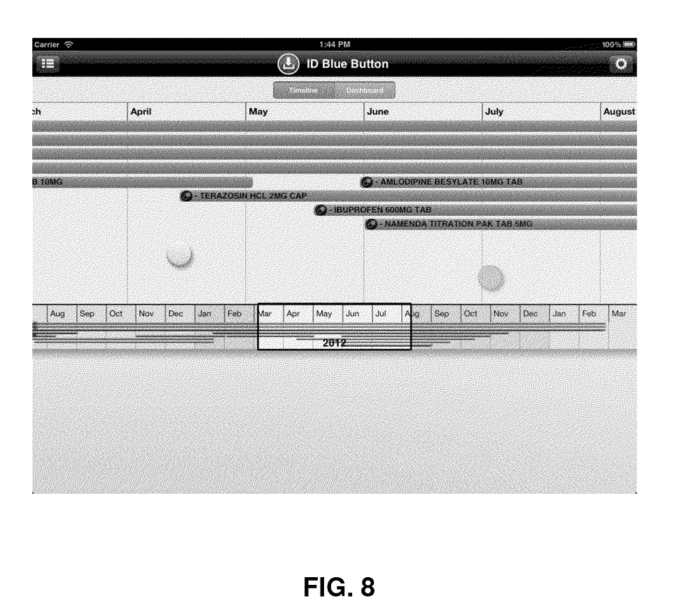

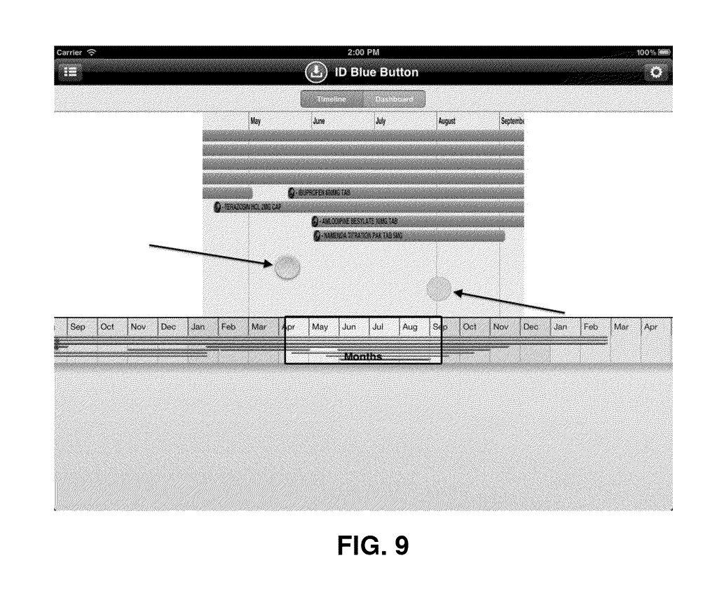

A second embodiment of the provided timeline is depicted in FIGS. 8-11. In FIG. 8, the timeline depicts different medications that were taken by the patient over the selected time interval. As explained above, the user can zoom out of the current display by contacting the touchscreen at two points and pinching the points together. As shown in FIG. 9, when the user moves his fingers towards each other (as represented by the circles), the scale of the timeline can be increased to show more data on a larger time frame.

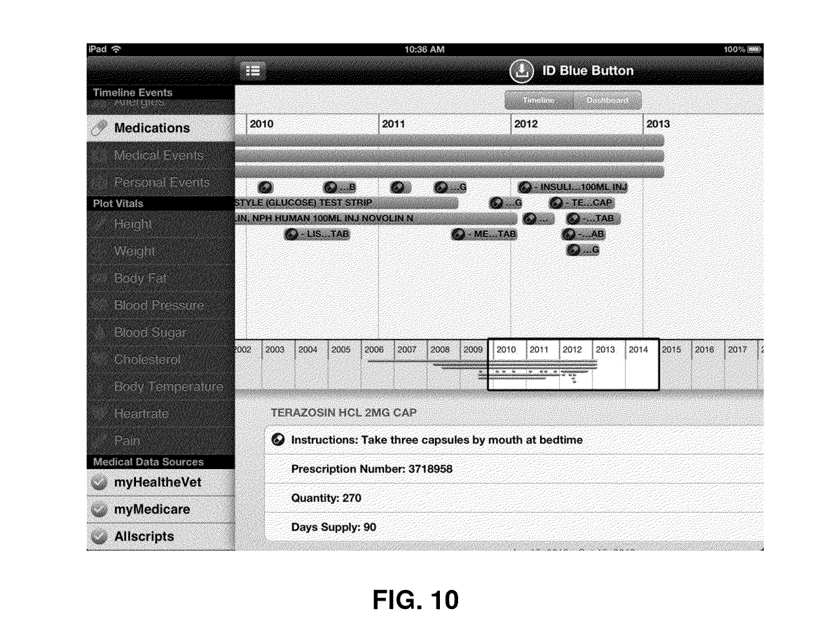

The provided timelines can be used to show different types of information. As shown in FIG. 10, the visual display can be used to show the combination of medications from multiple data sources on a single timeline. By selecting a particular medication, the timeline can also show the dosage instructions and other information associated with the particular medicine.

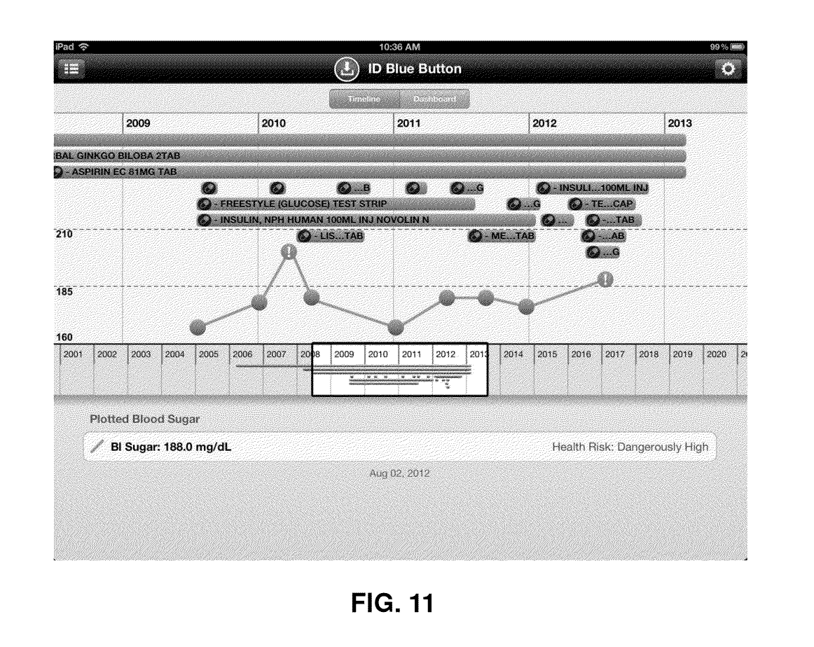

The provided visual displays can also be used indicate occurrences in which a patient's physiological parameter exceeds a previously determined threshold. For example, in the screenshot provided in FIG. 11, the patient's blood sugar level is charted along the timeline. As indicated at the bottom of the visual display, the threshold blood sugar level is 188.9 mg/dl. A level above this threshold indicates a health risk. The timeline indicates that in early 2010 and again around mid-2012, the patient suffered dangerously high blood sugar levels, as depicted by the exclamation point icon.

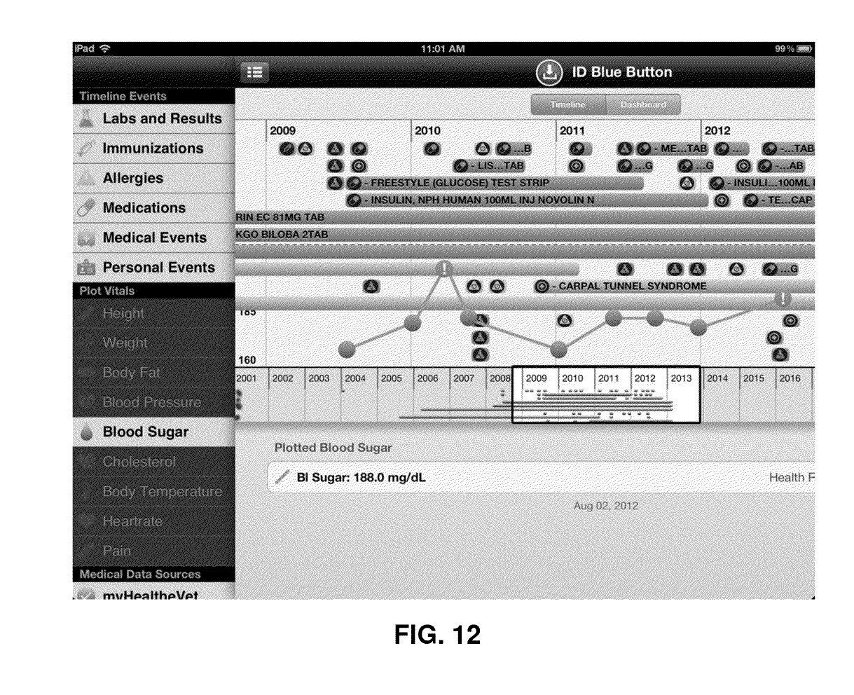

FIG. 12 depicts a graphic showing numerous medical events that occurred in the patient's medical history. As shown, these events can include laboratory and other test results, immunizations, allergic reactions, medications taken, adverse bodily conditions (such as carpal tunnel syndrome), depicted on the same timeline. The timeline also shows the selection of the physiological parameter of blood sugar with a specific data point selected by the user.

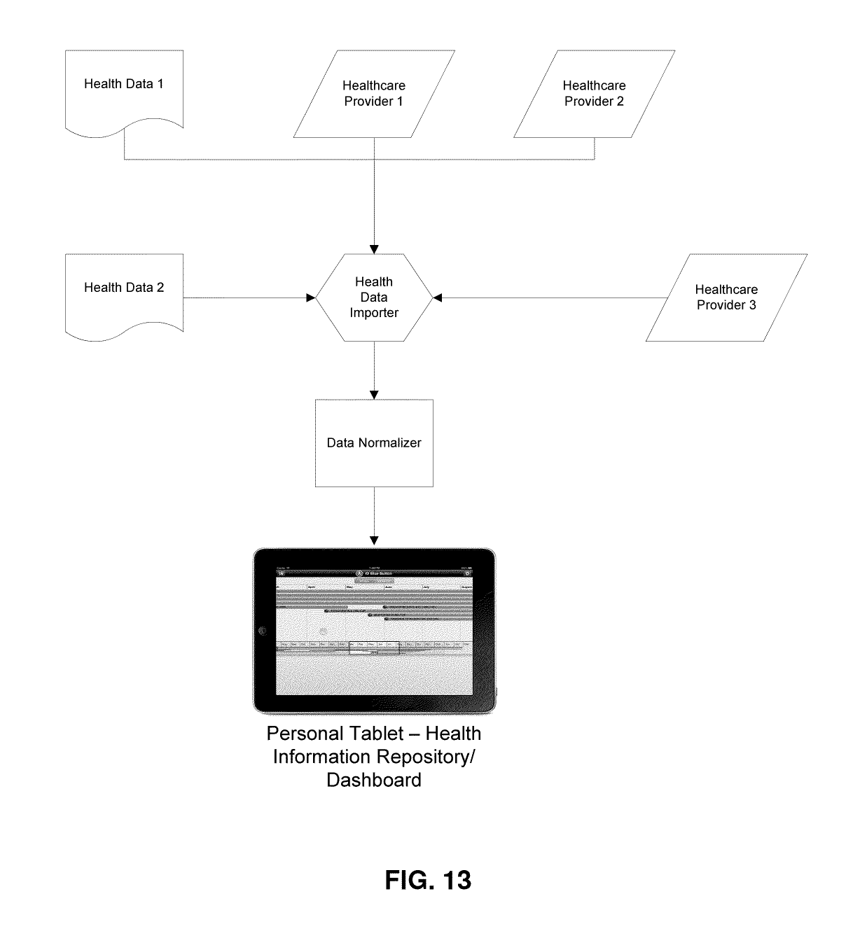

FIG. 13 provides an exemplary flow chart for generating visual displays in accordance with the invention. In preferred embodiments, the process for generating the provided visual displays will be conducted by computer software, a computer program, or computer application or “app”. The skilled artisan can use the provided flow chart to arrive at such a program. As shown, the patient's medical data is collected from multiple sources, represented by Health Data 1 and 2 and Healthcare Providers 1-3. The Heath Data can represent different medical databases that have accumulated aspects of the patient's medical history. This health data may be from an insurance provider, for example. The Healthcare Providers can represent the various doctors, physicians, medical practitioners, hospitals, and healthcare facilities that have treated the patient. Electronic data is collected from these various sources by a Health Data Importer and normalized into a unitary format by the Data Normalizer. The Health Data Importer and Data Normalizer can different aspects of the software or program run by the electronic device. Using the electronic device, the patient can request that information is to be collected using the Health Data Importer from various medical data sources. The Data Normalizer subsequently organizes the collected information into a common format for display on the interactive timeline.

Generally speaking, the import and export of data involves the automated or semi-automated input and output of data sets between different software applications. It often involves “translating” from the format used in one application into that used by another, where such translation is accomplished automatically via machine processes, such as transcoding, data transformation, and others. In certain embodiments of the invention, data collected from the various sources is translated and transported in a common electronic format.

Data normalization is the process of reducing data to its canonical form. For instance, Database normalization is the process of organizing the fields and tables of a relational database to minimize redundancy and dependency. Normalization usually involves dividing large tables into smaller (and less redundant) tables and defining relationships between them. The objective is to isolate data so that additions, deletions, and modifications of a field can be made in just one table and then propagated through the rest of the database using the defined relationships.

The provided aggregated timeline perspective of the patient's personal health history allows a more complete view of personal health than previously possible. Most importantly, it allows the patient to see and understand his own health picture. This gives the patient the ability and incentive to better his health outlook. The invention turns data into information, which has meaning and consequentially can offer insight as to the actions that can improve the health outlook of the patient.

It is also important to note that the invention is not limited to a specific device, source of data, type of data transport, or data representation. The basic concept behind the invention involves codifying the process of taking all of a patient's medical information and using that information to provide a meaningful representation for the patient. Accordingly, the invention in its broadest sense transcends specific sources, devices, networks, endpoint devices, and types of data.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. An electronic device, the device comprising:
a display screen;
a processor; and
computer instructions that when executed by the processor, generate a visual display on the display screen, wherein the visual display comprises a configurable timeline representative of a patient's medical data.

2. The electronic device of claim 1, wherein the medical data comprises data that has been requested by the patient via the electronic device.

3. The electronic device of claim 2, wherein the requested data is obtained from a plurality of medical data sources.

3. The electronic device of claim 1, wherein the medical data is stored on the electronic device.

4. The electronic device of claim 3, wherein the medical data is stored on the electronic device in a common data format independent of source.

6. The electronic device of claim 1, wherein the display screen is touch-sensitive.

7. The electronic device of claim 6, wherein the configurable timeline is able to be configured by touching the touch-sensitive display screen.

8. The electronic device of claim 7, wherein touching the display screen at a single point of contact and moving the point of contact laterally moves the timeline in the direction of lateral movement.

9. The electronic device of claim 7, wherein touching the display screen at two points of contact and moving the two points of contact closer to each other zooms out of the visual display.

10. The electronic device of claim 7, wherein touching the display screen at two points of contact and moving the two points of contact further from each other zooms into the visual display.

11. The electronic device of claim 1, wherein the electronic device is a tablet or smartphone.

12. The electronic device of claim 1, wherein the medical data comprises at least one physiological parameter selected from a group consisting of the following: height, weight, body fat, blood pressure, blood sugar, cholesterol, body temperature, heart rate, cognitive behavioral therapy, and pain level.

13. The electronic device of claim 12, wherein the visual display further comprises a threshold indicator for the physiological parameter, wherein a parameter level above the threshold indicator indicates a health risk.

14. The electronic device of claim 12, wherein the visual display further comprises a threshold indicator for the physiological parameter, wherein a parameter level below the threshold level indicates a health risk.

15. The electronic device of claim 1, wherein the visual display further comprises a medical event associated with the patient.

16. The electronic device of claim 15, wherein the medical event is organized along the configurable timeline.

17. The electronic device of claim 15, wherein the medical event is selected from a medical procedure, an immunization schedule, a medication regimen, a laboratory test or result, an allergic reaction, and an adverse bodily event.

18. The electronic device of claim 1, wherein the visual display further comprises a profile of the patient.

19. The electronic device of claim 18, wherein the profile comprises one or more types of information from a group consisting of the following: patient medical account information, patient emergency contact information, patient medical insurance information, hospitals and facilities associated with the patient, and medical practitioners associated with the patient.

20. A method for presenting a patient's medical data, the method comprising generating a visual display on a display screen of an electronic device, wherein the visual display comprises a configurable timeline representative of a patient's medical data.

21. The method of claim 20, wherein the medical data comprises data that has been requested by the patient via the electronic device.

22. The method of claim 21, wherein the requested data is obtained from a plurality of medical data sources.

23. The method of claim 20, wherein the medical data is stored on the electronic device.

24. The method of claim 23, wherein the medical data is stored on the electronic device in an Extensible Markup Language (XML) format.

25. The method of claim 20, wherein the display screen is touch-sensitive.

26. The method of claim 25, wherein the configurable timeline is able to be configured by touching the touch-sensitive display screen.

27. The method of claim 26, wherein touching the display screen at a single point of contact and moving the point of contact laterally moves the timeline in the direction of lateral movement.

28. The method of claim 27, wherein touching the display screen at two points of contact and moving the two points of contact closer to each other zooms out of the visual display.

29. The method of claim 27, wherein touching the display screen at two points of contact and moving the two points of contact further from each other zooms into the visual display.

30. The method of claim 20, wherein the electronic device is a tablet or smartphone.

31. The method of claim 20, wherein the medical data comprises at least one physiological parameter selected from a group consisting of the following: height, weight, body fat, blood pressure, blood sugar, cholesterol, body temperature, heart rate, cognitive behavioral therapy, and pain level.

32. The method of claim 20, wherein the visual display further comprises a threshold indicator for the physiological parameter, wherein a parameter level above the threshold indicator indicates a health risk.

33. The method of claim 20, wherein the visual display further comprises a threshold indicator for the physiological parameter, wherein a parameter level below the threshold level indicates a health risk.

34. The method of claim 20, wherein the visual display further comprises a medical event associated with the patient.

35. The method of claim 34, wherein the medical event is organized along the configurable timeline.

36. The method of claim 34, wherein the medical event is selected from a medical procedure, an immunization schedule, a medication regimen, a laboratory test or result, an allergic reaction, and an adverse bodily event.

37. The method of claim 20, wherein the visual display further comprises a profile of the patient.

38. The method of claim 37, wherein the profile comprises one or more types of information from a group consisting of the following: patient medical account information, patient emergency contact information, patient medical insurance information, hospitals and facilities associated with the patient, and medical practitioners associated with the patient.
